(19) United States
(12) Patent Application Publication
(10) Pub. No.: US 2025/0372724 A1
(43) Pub. Date: Dec. 4, 2025

(54) METHOD FOR PRODUCING ACCUMULATORS AND CORRESPONDING STACKING DEVICE FOR PRODUCING ACCUMULATORS

(71) Applicants: Giesecke + Devrient Currency Technology GmbH, Muenchen (DE); Volkswagen Aktiengesellschaft, Wolfsburg (DE)

(72) Inventor: Markus Sperl, Muenchen (DE)

(73) Assignees: Giesecke + Devrient Currency Technology GmbH, Muenchen (DE); Volkswagen Aktiengesellschaft, Wolfsburg (DE)

(21) Appl. No.: 19/246,152

(22) Filed: Jun. 23, 2025

Related U.S. Application Data
(63) Continuation of application No. PCT/EP2023/086921, filed on Dec. 20, 2023.

(30) Foreign Application Priority Data
Dec. 21, 2022 (DE) 10 2022 214 101.6

(51) Int. Cl. H01M 10/0585; B65H 29/22; B65H 29/52; B65H 31/30

(52) U.S. Cl. CPC H01M 10/0585; B65H 29/22; B65H 29/52; B65H 31/3036; B65H 2701/1826

(57) ABSTRACT

A method for producing accumulators which each have at least one cell stack, wherein to produce the cell stack, individual sheets are stacked via a stacking device in that the individual sheets are fed one after the other via a conveying line of the stacking device to a stacking wheel arrangement of the stacking device. The stacking wheel arrangement has two stacking wheels which are arranged in two planes one above the other. A predefined number of successive individual sheets are fed to one of the two stacking wheels. The predefined number corresponds to the number of individual sheets in a finished cell stack. A plurality of the individual sheets following the predefined number of individual sheets are fed to the other of the two stacking wheels.

This nonprovisional application is a continuation of International Application No. PCT/EP2023/086921, which was filed on Dec. 20, 2023, and which claims priority to German Patent Application No. 10 2022 214 101.6, which was filed in Germany on Dec. 21, 2022, and which are both herein incorporated by reference.

### BACKGROUND OF THE INVENTION

### Field of the Invention

The invention relates to a method for producing accumulators. In addition, the invention relates to a stacking device for producing accumulators.

### Description of the Background Art

Accumulators are storage devices for electrical energy and are widespread. They are constructed of multiple accumulator cells in some application cases, and are used in fields including the automotive field. Here, the accumulators then serve as so-called propulsion or traction batteries for driving hybrid or electric vehicles, for example.

Lithium-ion accumulators, which is to say accumulators composed of lithium-ion cells, are currently of particular interest in this connection. A multiplicity of examples are known here with regard to the precise construction. The production of lithium-ion cells in this connection is outlined in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-Ionen-Batteriezelle” [Production process for a lithium-ion battery cell], Frankfurt am Main, PEM der RWTH Aachen und VDMA Eigendruck (2018), for example.

### SUMMARY OF THE INVENTION

It is therefore an object of the invention to provide a method for producing accumulators. In addition, it is an object of the invention to provide a stacking device for producing accumulators.

This object is attained by a method and by a stacking device. The advantages and examples cited with respect to the method can also be applied correspondingly to the stacking device and vice versa.

In an example, the method according to the invention in this case can be designed for the manufacture of accumulators. A corresponding accumulator here typically has a number of accumulator cells, wherein such an accumulator cell customarily has a cell housing or a cell enclosure. Depending on the application case, such an accumulator is therefore made of a single accumulator cell, for example. Customarily, however, a corresponding accumulator has multiple such accumulator cells, and generally forms a battery or a battery module. A corresponding battery, in turn, typically has a battery housing, and a corresponding battery module customarily has a module housing or a carrier unit for accumulator cells. If the accumulator is designed as a battery, then in some cases it has a number of the aforementioned battery modules, which is to say at least one such battery module and typically several.

Regardless thereof, each accumulator produced via the method has at least one cell stack that is made of stacked single sheets. If the accumulator is constructed of aforementioned accumulator cells, each accumulator cell typically has such a cell stack, namely exactly one, in particular. Moreover, each one of these accumulator cells is then preferably designed as a so-called pouch cell.

Furthermore, the cell stack expediently forms a so-called electrode stack. This means that a layering or stacking that has electrode materials is present in the cell stack. In addition, a corresponding accumulator is preferably designed as a lithium-ion accumulator. Therefore, the layering or stacking in the cell stack typically has an anode material, a separator material, and a cathode material.

Suitable single sheets for manufacturing a corresponding cell stack for a lithium-ion accumulator and a possible method for producing such single sheets are described in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-Ionen-Batteriezelle” [Production process for a lithium-ion battery cell], Frankfurt am Main, PEM der RWTH Aachen und VDMA Eigendruck (2018), for example. The corresponding single sheets are referred to there as “sheets.”

In this connection, three different sheets, which is to say single sheets, are manufactured in this specific example, namely anode single sheets a, which have an anode material, separator single sheets b, which have a separator material, and cathode single sheets c, which have a cathode material. To produce a corresponding cell stack, such single sheets are then expediently stacked in a sequence abcabc and so forth.

Single sheets can be used that are designed as so-called monocells. Such monocell single sheets typically have an anode material, a cathode material, and a separator material located therebetween.

The single sheets can have a length, a width, and a height or thickness. For the height, a value is typical in this case that lies in the range of 0.05 mm to 2.5 mm and, in particular, in the range of 0.1 mm to 1.5 mm. For length and width, values are customary in each case that are greater by at least a factor of 5 or by at least a factor of 10.

Corresponding single sheets are now stacked during the course of performing the method, which is to say the method according to the invention, to form cell stacks. The method for producing accumulators thus includes at least one method part of stacking, in which single sheets are stacked. This method part of stacking is performed in this case via the stacking device according to the invention, namely in completely automated fashion, in particular.

The stacking device, in turn, which is to say the stacking device according to the invention, is designed to produce the above-described accumulators via the method according to the invention and, in particular, to automatically perform the method part of stacking in at least one operating mode. The automatic performance in this case is typically controlled by a control unit of the stacking device. Regardless thereof, the stacking device, hereinafter also called ‘device’ for short, has a conveyor line as well as a stacking wheel arrangement.

Two stacking wheels can be arranged in two planes one above the other in the stacking wheel arrangement in this case. “One above the other” here may mean that the two planes are arranged offset from one another in the vertical direction with respect to the earth. Furthermore, depending on the design version, the two stacking wheels in this case are arranged above one another or they are additionally arranged offset from one another in the horizontal direction with respect to the earth.

In any case, during the course of performing the method part of stacking, the single sheets are now fed consecutively to the stacking wheel arrangement via the conveyor line. A predetermined number of successive single sheets is then fed to one of the two stacking wheels and subsequently several of the single sheets following the predetermined number of single sheets are fed to the other of the two stacking wheels. In this connection, the predetermined number of single sheets then corresponds to the intended number of single sheets in a finished cell stack.

Furthermore, the single sheets typically can be fed continuously to the stacking wheel arrangement. This can mean that the conveyor line typically conveys the single sheets at a continuous speed and that the speed preferably is not changed even when a switchover takes place from feeding single sheets to one of the stacking wheels to feeding single sheets to the other of the stacking wheels. Thus a continuous supply of single sheets to the stacking wheel arrangement is specified, as it were. The two stacking wheels in the stacking wheel arrangement are then, in particular, used in alternation in order to stack single sheets to form cell stacks.

Expediently, the single sheets fed by the conveyor line are furthermore already arranged in an intended order on the conveyor line, at least inasmuch as different single sheets are to be stacked, and/or the single sheets are aligned and oriented in an intended manner, and thus an intended side thereof, in particular, lies on the conveyor line.

It is furthermore advantageous when the stacking device has a distributor unit that is positioned between the conveyor line and the stacking wheel arrangement. The corresponding distributor unit here has two branches, namely a first branch and a second branch, wherein a branch is associated with each of the two stacking wheels, namely the first stacking wheel and the second stacking wheel, which is to say the first branch with the first stacking wheel and the second branch with the second stacking wheel. During the course of performing the method, single sheets are then fed to each of the two stacking wheels via one of the two branches, wherein the single sheets preferably are conveyed either into the first branch or into the second branch as a function of a switch position of a switch of the distributor unit.

If the distributor unit now has an aforementioned switch, then this switch preferably is formed via a distributor roller. The distributor roller in this case preferably is movable in the vertical direction relative to the earth, or it is movable in a good approximation of the vertical direction. “In a good approximation” in this case may mean that the actual direction preferably does not deviate more than 40°, further preferably not more than 25°, and in particular not more than 15° from the vertical direction.

Also preferably, the distributor roller can be movable between two vertical positions, namely between a first position and a second position. In the first position, the single sheets fed to the switch are then conveyed via the switch into the first branch, and in the second position, the single sheets fed to the switch are conveyed via the switch into the second branch.

The distributor roller can be augmented by a roller pair, which likewise is part of the switch. This roller pair is then made of two rollers, which typically are arranged offset from one another in the aforementioned vertical direction.

Also preferably, at least one of these two rollers can be driven so that the two rollers form a so-called conveyor roller pair. This means that these rollers rotate in opposite directions in operation and thereby convey fed single sheets so that these sheets are passed through between these rollers.

In the switch, moreover, the distributor roller preferably forms such a conveyor roller pair, either together with the one roller of the roller pair or together with the other roller of the roller pair, depending on the vertical position of the distributor roller.

It is also expedient when the first branch of the distributor unit can have at least one conveyor roller pair for conveying the single sheets. Additional examples are typical in which the first branch has at least two conveyor roller pairs, namely one conveyor roller pair of a first type and one conveyor roller pair of a second type. The two types differ here with regard to, e.g., the diameter of the rollers that make up the corresponding conveyor roller pairs.

The first branch can have at least one guide plate pair with two guide plates that are, in particular, arranged one above the other. The corresponding guide plates serve in this case to guide the single sheets during conveying through the first branch. This means that the single sheets conveyed through the first branch are passed through between the two guide plates of the guide plate pair.

The above-described guide plates additionally can have openings, namely slots, in particular. In order to convey the single sheets, preferably projections on the rollers of an aforementioned conveyor roller pair then reach through the openings so that the conveying of the single sheets is accomplished with the aid of the projections.

Such projections can be annular in design, for example. In this case, the annular projections of each roller are then passed around an axis of the roller and, viewed along the axis, arranged in a row with spacing. Consequently, then, a rectangular toothing, in particular, appears in profile on the rollers.

Depending on the application case, the second branch of the distributor unit can have none, one, or a plurality of the above-described features of the first branch of the distributor unit.

According to at least one design version, moreover, the rollers of the above-described switch also have such projections. In the case of the distributor roller, however, the annular projections preferably are arranged offset in alternation, once in a transverse direction perpendicular to the axis and once in the direction opposite the transverse direction, when viewed along an axis of the distributor roller.

A guide plate that has a V-shape can be formed by two sides is additionally associated with the distributor roller. Both sides typically have openings, and the distributor roller is expediently arranged between the two sides.

Furthermore, one of the stacking wheels, namely the first stacking wheel, has an axis. Also favorable is an example in which the first stacking wheel can be designed as a driven stacking wheel, and consequently rotates about the axis in a direction of rotation during operation.

Regardless thereof, the first stacking wheel preferably has multiple fingers, which, when viewed along the axis, are arranged spaced apart from one another in a row. In addition, the first stacking wheel preferably has multiple such rows, which are distributed around the axis. Examples with more than two fingers per row and more than ten rows are typical here. A single sheet fed to the first stacking wheel is then typically introduced into a gap between two successive rows in the circumferential direction or in the aforementioned direction of rotation.

Furthermore, the fingers can be curved in design. The fingers here are curved opposite the aforementioned direction of rotation, in particular.

The other stacking wheel of the two stacking wheels, namely the second stacking wheel, can have none, one, or a multiplicity of the above-described features of the first stacking wheel, depending on design version. Preferably, the stacking wheels of the stacking wheel arrangement are designed identically.

It is also expedient when a stacking table on which single sheets are stacked by the respective stacking wheel to form cell stacks can be associated with each of the stacking wheels. Preferably, a common gripper of the stacking device is then associated with the stacking tables, by which means completely stacked cell stacks are removed from the stacking tables.

Depending on design version, the completely stacked cell stacks are additionally turned by the gripper.

Regardless thereof, it is advantageous when the completely stacked cell stacks are fed to a continuous furnace by the gripper. In the continuous furnace, the completely stacked cell stacks are then subjected to a heat treatment. During this heat treatment, a pressure preferably is exerted on the stacks, namely typically in the stacking direction. In this case, a hot pressing, as it were, is then carried out by the continuous furnace.

The improvements and advantages described in connection with the method should also be applied correspondingly to the stacking device and vice versa.

In summary, the idea underlying the method according to the invention and underlying the stacking device according to the invention can also be expressed as follows: Monocells are to be stacked to produce an accumulator. Stacking wheels are expedient for this purpose. Since the pack is complete with regard to quantity after a specific number of monocells, the inflow of monocells is then diverted to a different path and thus to a different stacker/stacking wheel. Afterwards, a continuous flow of packs is created again via a gripping mechanism. For this purpose, two stackers are loaded in alternation with the desired number of monocells using a tandem principle. A manipulator designed as a gripper then collects the packs from the stacker that is reaching completion in each case. A double conveyor belt with heated belts, as a continuous furnace, provides for the removal and lamination of the pack.

Various advantages are then connected therewith: a “taping” with adhesive strips for a temporary fixing of the stack is no longer necessary, since the fixing takes place in the furnace immediately after the stacking process. An uninterrupted fixing by clamping is provided in this case. The packs ultimately are positioned “the right way around” again after the cells have been turned around in the meantime by the stacking process. The two material flows created in the interim by the tandem operation have become one again at the end. The length of the continuous furnace is determined by the required exposure time to the temperature for lamination and the number of cells per stack.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a stacking device having a conveyor line, a distributor unit, a stacking wheel arrangement, and a gripper,

FIG. 2 shows enlarged, a lower branch of the distributor unit,

FIG. 3 shows enlarged, a roller pair of the distributor unit,

FIG. 4 shows enlarged, a switch of the distributor unit,

FIG. 5 shows enlarged, a stacking wheel of the stacking unit,

FIG. 6 shows enlarged, two gripper jaws of the gripper, and

FIG. 7 shows a single sheet for a cell stack of an accumulator.

### DETAILED DESCRIPTION

A stacking device 2 described below by way of example serves to automatically perform a method part of stacking, in which single sheets 4 are stacked to form cell stacks 6. The method part of stacking in this case is part of a method for producing accumulators (not shown), namely lithium-ion accumulators, wherein each accumulator has at least one such cell stack 6. The automatic performance in this case typically is controlled by a control unit, not depicted, of the stacking device 2.

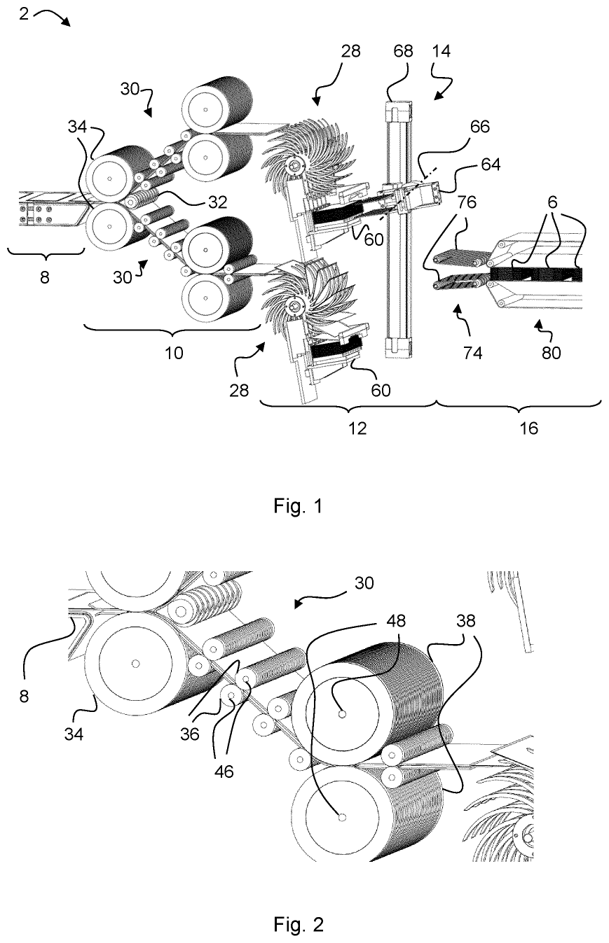

The stacking device 2 now has a conveyor line 8, a distributor unit 10, a stacking wheel arrangement 12, and preferably also a gripper 14. Also preferably, the stacking device 2 has a continuous furnace 16. A design version with gripper 14, namely with a first gripper 14, and with continuous furnace 16 is shown in FIG. 1 here. FIG. 2 to FIG. 6 depict various details from FIG. 1 in enlarged form.

In operation of the stacking device 2, and thus during the course of performing the method part of stacking, the single sheets 4 are fed continuously to the distributor unit 10 by the conveyor line 8. The conveyor line 8 in the case of the design version from FIG. 1 is designed here as a single conveyor belt that conveys the single sheets 4 in a conveying direction.

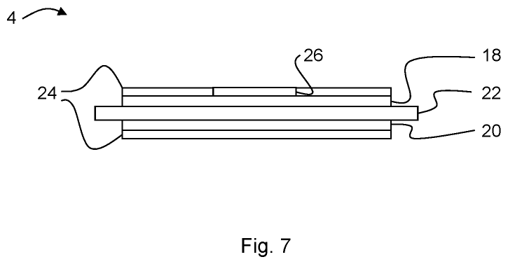

By way of example, furthermore, all fed single sheets 4 are designed identically. Such a single sheet 4 is sketched as an example in FIG. 7. It is designed as a so-called monocell and has a layer made of an anode material 18, a layer made of a cathode material 20, and a layer located therebetween made of a separator material 22. In addition, the single sheet 4 has two electrically conductive current collector films 24, wherein one of the current collector films 24 adjoins the anode material 18 and the other adjoins the cathode material 20. Each of the two current collector films 24 here forms a so-called current collector tab 26, wherein the two current collector tabs 26 protrude on opposite sides of the single sheet 4. In FIG. 7, only the current collector tab 26 of the current collector film 24 that projects out of the plane of the drawing is visible on the anode material 18.

A multiplicity of these single sheets 4, already lined up one after the other in the conveying direction, now lie on the conveyor belt shown in FIG. 1. In this case, these single sheets 4 are all aligned and oriented in the same manner. The single sheets 4 are then fed to the distributor unit 10 in this fashion during operation of the stacking device 2. In this process, the conveyor line 8 typically conveys the single sheets 4 at a predetermined speed, which preferably is kept constant over a period of time during which multiple cell stacks 6 are stacked.

The cell stacks 6 are furthermore stacked via the stacking wheel arrangement 12 of the stacking device 2, which has two stacking wheels 28 for this purpose. In order to distribute the single sheets 4 fed via the conveyor line 8 to the stacking wheels 28, furthermore, the distributor unit 10 is positioned between the conveyor line 8 and the stacking wheel arrangement 12, wherein the distributor unit 10 has a branch 30 for each stacking wheel 28. One branch 30, through which single sheets 4 can be fed to the corresponding stacking wheel 28, is consequently associated with each stacking wheel 28.

The stacking wheels 28 are furthermore arranged in two planes one above the other. This means that the stacking wheels 28 are arranged offset from one another in the vertical direction with respect to the earth, or at least in a good approximation of the vertical direction. “In a good approximation” in this case means that the actual direction preferably does not deviate more than 40°, further preferably not more than 25°, and in particular not more than 15° from the vertical direction.

In contrast, the stacking wheels 28 preferably are not offset in the horizontal direction with respect to the earth, or at least in a good approximation of the horizontal direction. “In a good approximation” in this case means that the actual direction preferably does not deviate more than 40°, further preferably not more than 25°, and in particular not more than 15° from the horizontal direction.

Preferably, therefore, the stacking wheels 28 are arranged one above the other, such as is indicated in FIG. 1. For this reason, one of the stacking wheels 28, namely the one depicted at the top in FIG. 1, is referred to hereinbelow as the upper stacking wheel 28, and the other stacking wheel 28, namely the one depicted at the bottom in FIG. 1, as the lower stacking wheel 28. The branch 30 associated with the upper stacking wheel 28 is supplementally referred to as the upper branch 30, and the branch 30 associated with the lower stacking wheel 28 as the lower branch 30.

In order to now make possible a distribution of the single sheets 4 to the two branches 30, the distributor unit 10 typically has a switch. The switch here preferably is formed via a distributor roller 32, such as is depicted in FIG. 4. The distributor roller 32 in this case is adjustable in the aforementioned vertical direction, or at least in a good approximation of the vertical direction, and in particular is movable between two vertical positions. In the upper vertical position, the single sheets 4 fed to the switch are then conveyed through the switch into the upper branch 30, and in the lower vertical position, the single sheets 4 fed to the switch are then conveyed through the switch into the lower branch 30.

The distributor roller 32 in the example is augmented by a roller pair, which likewise is part of the switch. This roller pair is made of two rollers 34, which are arranged one above the other. Consequently, the roller pair has an upper roller 34 and a lower roller 34.

In addition, at least one of the two rollers 34 is driven so that they form a so-called conveyor roller pair. This means that these rollers 34 rotate in opposite directions in operation and thereby convey fed single sheets 4 so that these sheets are passed through between the rollers 34.

In the switch, the distributor roller 32 expediently forms, in addition, such a conveyor roller pair, either together with the upper roller 34 of the roller pair or together with the lower roller 34 of the roller pair, depending on the vertical position of the distributor roller 32.

Moreover, typically the aforementioned branches 30 customarily each have roller pairs that are designed as conveyor roller pairs. In the example according to FIG. 1, each branch 30 has one roller pair with rollers 36 of a first type and one roller pair with rollers 38 of a second type. The two types differ here with regard to the diameter of the rollers 36, 38.

Furthermore, an example of the stacking device 2 is preferred in which the distributor unit 10, as in the case of the design version from FIG. 1, has at least two guide plates 40 that, in particular, are arranged one above the other and consequently form a guide plate pair. In this case, then, the single sheets 4 are expediently passed through between the guide plates 40 of the guide plate pair.

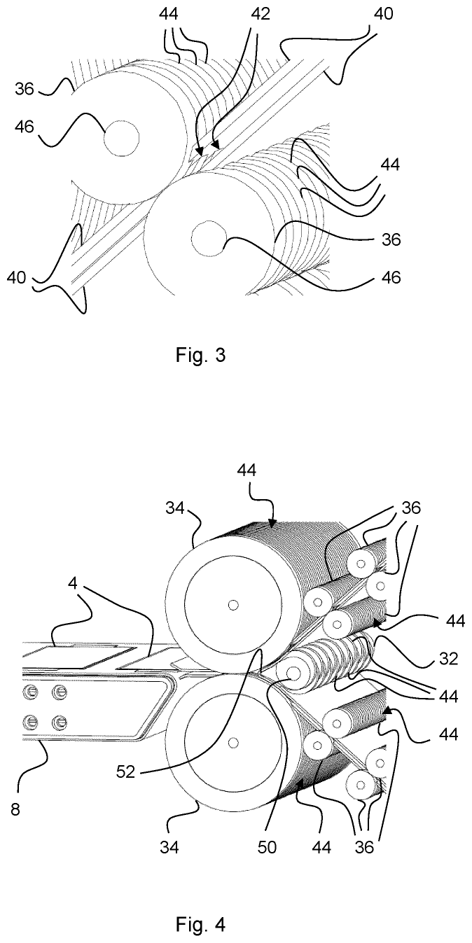

In example from FIG. 1, the guide plates 40 in this case additionally have openings 42, in particular slots. This is indicated at least in FIG. 3. In order to convey the single sheets 4, projections 44 on the rollers 36, 38 then reach through the openings 42 so that the conveying of the single sheets 4 is accomplished with the aid of the projections 44.

Those projections 44 are annular in design in the example from FIG. 1. In this case, the projections 44 of each roller 36, 38 are passed around an axis 46, 48 of the roller and, viewed along the axis 46, 48, arranged in a row with spacing. Consequently, then, a rectangular toothing appears in profile on the rollers 36, 38.

According to the design version from FIG. 1, moreover, the rollers of the above-described switch also have such projections 44. In the case of the distributor roller 32, however, when viewed along an axis 50 of the distributor roller 32, the annular projections 44 are arranged offset in alternation, once in a transverse direction perpendicular to the axis 50 and once in the direction opposite the transverse direction. This is visible in FIG. 4.

In addition, the distributor roller 32 in the design version from FIG. 1 is combined with a guide plate 52 that has a V-shape formed by two sides. Both sides have openings, not shown in detail, that are similar to the openings 42, and the distributor roller 32 is positioned between the two sides. Single sheets 4 are then conducted through the upper side to the upper branch 30 and through the lower side into the lower branch 30.

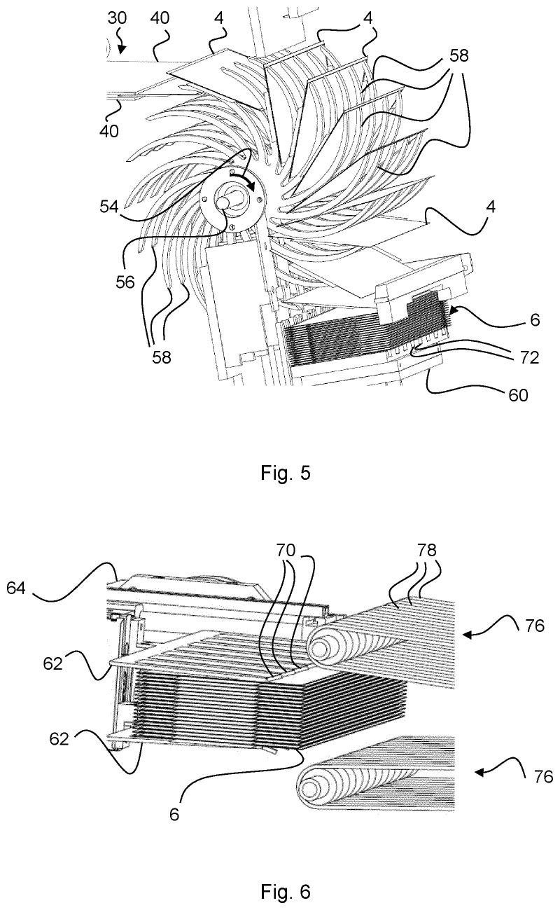

The stacking wheels 28 of the stacking wheel arrangement 12 further preferably are designed identically. It is then typically the case here that each stacking wheel 28 is designed as a driven stacking wheel 28, and consequently rotates about an axis 56 in a direction of rotation 54 during operation. Furthermore, this wheel preferably has multiple fingers 58, which, when viewed along the axis 56, are arranged spaced apart from one another in a row. In addition, this stacking wheel 28 preferably has multiple such rows, which are distributed around the axis 56. Examples with more than two fingers 58 per row and more than ten rows are typical here. A stacking wheel 28 designed in this way is shown in FIG. 5. A fed single sheet 4 is then introduced into a gap between two successive rows in the direction of rotation.

Furthermore, the fingers 58 preferably are curved in design, such as is the case in the example from FIG. 1. Further preferably, the fingers 58 here are then curved opposite the direction of rotation 54.

It is also expedient when a stacking table 60, on which the single sheets 4 fed to the applicable stacking wheel 28 are stacked to form cell stacks 6, is associated with each stacking wheel 28 of the stacking wheel arrangement 12.

In addition, the stacking device 2 preferably is designed and configured such that the two stacking wheels 28 of the stacking wheel arrangement 12 in alternation stack single sheets 4 to form cell stacks 6. This means that enough single sheets 4 for a cell stack 6 are first conveyed into one of the branches 30. Then the switch position of the switch of the distributor unit 10 is changed, which is to say, in particular, the vertical position of the distributor roller 32 is changed, so that the subsequent single sheets are fed to the other branch 30. As a result, cell stacks 6 are then completely stacked on the stacking tables 60 in alternation.

Furthermore, the stacking device 2 preferably has the first gripper 14 already mentioned previously, such as in the example from FIG. 1. This first gripper 14 in this case is then typically associated with the two stacking tables 60 of the stacking wheel arrangement 12, so that completely stacked cell stacks 6 are removed from the two stacking tables 60 by the first gripper 14. If the stacking device 2 additionally has the aforementioned continuous furnace 16, as is preferred, then the first gripper expediently feeds the completely stacked cell stacks 6 to the continuous furnace 16. During the course thereof, the cell stacks 6 are turned according to at least one design version.

Various examples are expedient for the first gripper 14. In the case of the example from FIG. 1, the first gripper 14 has two gripper jaws 62, which are movable toward one another and away from one another, by which means a grabbing, as it were, is made possible. The two gripper jaws 62 are furthermore connected by a telescoping arm 64 to a shaft 66, about which the telescoping arm 64 is rotatable. The shaft 66, in turn, is mounted on a rail 68 so as to be vertically movable in the exemplary example from FIG. 1.

In the case of the example from FIG. 1, the two gripper jaws 62 are furthermore identically designed, and each have a shape that is reminiscent of a comb. In order to form such a comb shape here, multiple parallel slats 70 are arranged next to one another. This is evident from FIG. 6. In order to grip a completely stacked cell stack 6 from one of the stacking tables 60, the slats 70 of the lower gripper jaw 62 are then introduced into suitably formed grooves 72 in the stacking table 60 so that the corresponding slats 70 are positioned below the lowest single sheet 4 prior to the grasping of the cell stack 6. The grooves 72 are clearly visible in FIG. 5.

As already explained previously, the first gripper 14 preferably is used to feed completely stacked cell stacks 6 to the aforementioned continuous furnace 16. In this case, at least the continuous furnace 16 in the example from FIG. 1 has an additional gripper 74, namely a second gripper 74. The second gripper 74 in this case is formed by two gripper jaws 76. Each of these gripper jaws 76 here is designed in the manner of a single conveyor belt with two guide rollers, but instead of a single wide belt, multiple narrow bands 78 are stretched between the two guide rollers and arranged next to one another in this design, as is shown in FIG. 6. Here, a gap is left between each of the bands 78 so that the slats 70 of the gripper jaws 62 of the first gripper 14 can be positioned between the bands 78. In addition, the two gripper jaws 76 of the second gripper 74 are each supported such that they can pivot about an axis so that they can be moved like the two jaws of pincers.

Following the second gripper 74 of the continuous furnace 16 is a heatable, and in operation heated, conveyor line 80 of the continuous furnace 16, according to the example from FIG. 1. In the example, this is, by way of example, composed of two conveyor belts that are arranged one above the other, and between which the cell stacks 6 are passed through. In this case, pressure is preferably exerted by the two conveyor belts on the cell stacks 6 passing through, which pressure acts on the cell stacks 6 in the vertical direction and opposite the vertical direction.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing accumulators that each have at least one cell stack, wherein single sheets are stacked via a stacking device in order to manufacture the cell stack, the method comprising:
feeding the single sheets consecutively to a stacking wheel arrangement of the stacking device via a conveyor line of the stacking device, the stacking wheel arrangement having two stacking wheels that are arranged in two planes one above the other;
feeding a predetermined number of successive single sheets to one of the two stacking wheels, the predetermined number corresponding to the number of single sheets in a finished cell stack; and
feeding several of the single sheets following the predetermined number of single sheets to the other of the two stacking wheels.

2. The method according to claim 1, wherein single sheets are stacked to form cell stacks via the two stacking wheels in alternation.

3. The method according to claim 1, wherein the stacking device has a distributor unit that is positioned between the conveyor line and the stacking wheel arrangement, wherein the distributor unit has a first branch and a second branch, wherein single sheets are fed to each of the two stacking wheels via one of the first or second branches, and wherein the single sheets are fed either to the first branch or to the second branch as a function of a vertical position of a distributor roller.

4. The method according to claim 3, wherein the first branch has a roller pair, via which single sheets are conveyed through the first branch.

5. The method according to claim 4, wherein the first branch has a guide plate pair with two guide plates that are arranged one above the other, between which the single sheets that are conveyed through the first branch are passed through, wherein each of the rollers of the roller pair is designed as a roller with an axis and with annular projections, wherein the annular projections are designed to run around the axis and, when viewed along the axis, are arranged in a row with spacing from one another, and wherein the single sheets that are carried through the first branch are conveyed via the projections of the rollers, which reach through openings in the guide plates of the guide plate pair for this purpose.

6. The method according to claim 1, wherein one of the two stacking wheels has an axis as well as multiple fingers distributed around the axis, and wherein a single sheet fed to this stacking wheel is guided into a gap between two successive fingers in a direction of rotation.

7. The method according to claim 1, wherein a stacking table of the stacking wheel arrangement is associated with each of the stacking wheels, on which table single sheets are stacked by the respective stacking wheel to form cell stacks, and wherein a common gripper of the stacking device is associated with the stacking tables, via which completely stacked cell stacks are removed from the stacking tables.

8. The method according to claim 7, wherein the completely stacked cell stacks are turned by the gripper.

9. The method according to claim 7, wherein the completely stacked cell stacks are fed to a continuous furnace by the gripper.

10. A stacking device for producing accumulators via the method according to claim 1.
